(19) United States
(12) Patent Application Publication
(10) Pub. No.: US 2009/0248513 A1
(43) Pub. Date: Oct. 1, 2009

(54) ALLOCATION OF PRESENTATION POSITIONS

(75) Inventors: Gagan Aggarwal, Sunnyvale, CA (US); Jon Feldman, New York, NY (US); Martin Pal, Metuchen, NJ (US); Shanmugavelayutham Muthukrishnan, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/060,758

(22) Filed: Apr. 1, 2008

(51) Int. Cl. G06Q 30/00; G06F 17/18; G06F 15/00

(52) U.S. Cl. 705/14; 705/37; 702/181; 702/127

(57) ABSTRACT

Co-performance measurements can be determined for a plurality of content items, each co-performance measurement being associated with a corresponding content item and each co-performance measurement being a measure of the effect of the corresponding content item on the performance of one or more other content items that are presented with the corresponding content item. A set of content items can be selected for presentation to a viewer, wherein the set of content items comprises the content items that maximize a cumulative performance of the set of content items. Each content item can be assigned to a presentation position based on the co-performance measurement of each content item.

### BACKGROUND

This document relates to content presentation.

The rise of the Internet has enabled access to a wide variety of content items, e.g., video and/or audio files, web pages for particular subjects, news articles, etc. Such access to these content items has likewise enabled opportunities for targeted advertising. For example, content items of particular interest to a user can be identified by a search engine in response to a user query. One example search engine is the Google search engine provided by Google Inc. of Mountain View, Calif., U.S.A. The query can include one or more search terms, and the search engine can identify and, optionally, rank the content items based on the search terms in the query and present the content items to the user (e.g., according to the rank). This query can also be an indicator of the type of information of interest to the user. By comparing the user query to a list of keywords specified by an advertiser, it is possible to provide targeted advertisements to the user.

Another form of online advertising is advertisement syndication, which allows advertisers to extend their marketing reach by distributing advertisements to additional partners. For example, third party online publishers can place an advertiser's text or image advertisements on web pages that have content related to the advertisement. As the users are likely interested in the particular content on the publisher webpage, they are also likely to be interested in the product or service featured in the advertisement. Accordingly, such targeted advertisement placement can help drive online customers to the advertiser's website.

A limited number of advertisements can be presented on web pages. A selection process can be used to determine which advertisements should be presented in the positions that are available on a particular webpage. An auction is one example of a selection process. Advertisers can submit bids that represent the price that the advertiser is willing to pay to occupy a position on the webpage. The bids can be a price that the advertiser will pay per action unit (e.g., a click, a defined number of impressions, or a conversion). Advertisements can be selected according to bid price, the past performance of the advertisement, or a combination of these and/or other factors. Some auctions are performed based on the assumption that each advertisement's performance is independent of the other advertisements that appear on a page with the advertisement. In some situations, this assumption may not accurately reflect the performance of advertisements and may result in a less than optimal assignment of advertisements.

### SUMMARY

In general, one aspect of the subject matter described in this specification can be embodied in a method of allocating presentation slots. The method of allocating presentation slots can include the actions of determining co-performance measurements for a plurality of content items, each co-performance measurement being associated with a corresponding content item and each co-performance measurement being a measure of the effect of the corresponding content item on the performance of one or more other content items that are presented with the corresponding content item, determining a set of content items for presentation to a viewer, wherein the set of content items comprises the content items that maximize a cumulative performance of the set of content items, and assigning each content item in the set of content items to a presentation position based on the co-performance measurement of each content item. Other embodiments of this aspect include corresponding systems, apparatus, and computer program products.

These and other implementations can optionally include one or more of the following features. The co-performance measurements can be continuation probabilities that represent the probability that the viewer views another content item after viewing the content item. The content item can be an online advertisement, and the co-performance measurements can be click-through rates. The set of content items can be the online advertisements that maximize a cumulative presentation position value on a web page.

Particular embodiments of the subject matter described in this specification can be implemented so as to realize one or more of the following advantages. More efficient selection of content items for an auction can be performed; a truthful auction can be achieved; the total value of a page can be increased; and/or interdependence of content items can be accounted for in an auction. These advantages can be separately realized or realized in combination in various implementations.

These various optional advantages and features can be separately realized and need not present in any particular embodiment. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online environment.

FIG. 2 is a block diagram of an example web page having advertisement slots.

FIG. 3 is a block diagram of an example allocation subsystem.

FIG. 4 is a flow chart of an example process for allocating content items.

Like reference numbers and designations in the various drawings indicate like elements.

### DETAILED DESCRIPTION

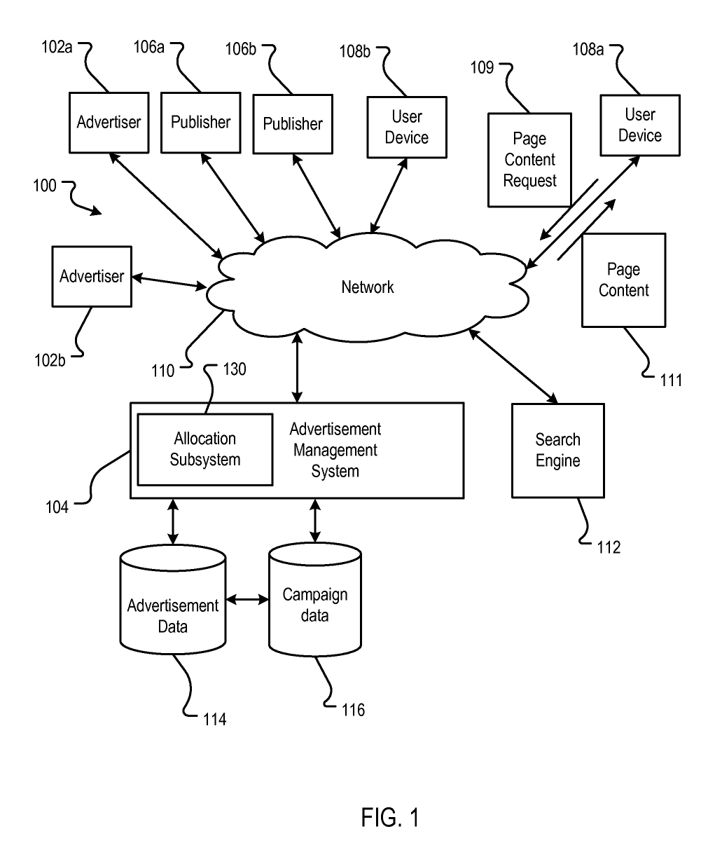

FIG. 1 is a block diagram of an example online environment 100. The online environment 100 can facilitate the identification and serving of content items, e.g., web pages, advertisements, etc., to users. A computer network 110, such as a local area network (LAN), wide area network (WAN), the Internet, or a combination thereof, connects advertisers 102a and 102b, an advertisement management system 104, publishers 106a and 106b, user devices 108a and 108b, and a search engine 112. Although only two advertisers (102a and 102b), two publishers (106a and 106b) and two user devices (108a and 108b) are shown, the online environment 100 may include many thousands of advertisers, publishers and user devices.

### § 1.0 Advertisement Publishing and Tracking

In some implementations, one or more advertisers 102a and/or 102b can directly, or indirectly, enter, maintain, and track advertisement information in the advertising management system 104. The advertisements can be in the form of graphical advertisements, such as banner advertisements, text only advertisements, image advertisements, audio advertisements, video advertisements, advertisements combining one of more of any of such components, etc., or any other type of electronic advertisement document. The advertisements may also include embedded information, such as a links, meta-information, and/or machine executable instructions, such as HTML or JavaScript™.

A user device, such as user device 108a, can submit a page content request 109 to a publisher or the search engine 112. In some implementations, the page content 111 can be provided to the user device 108a in response to the request 109. The page content can include advertisements provided by the advertisement management system 104, or can include executable instructions, e.g., JavaScript™, that can be executed at the user device 108a to request advertisements from the advertisement management system 104. Example user devices 108 include personal computers, mobile communication devices, television set-top boxes, etc.

Advertisements can also be provided to the publishers 106. For example, one or more publishers 106a and/or 106b can submit advertisement requests for one or more advertisements to the system 104. The system 104 responds by sending the advertisements to the requesting publisher 106a or 106b for placement on one or more of the publisher's web properties (e.g., websites and other network-distributed content). The advertisements can include embedding links landing pages, e.g., pages on the advertisers' 102 websites, that a user is directed to when the user clicks an ad presented on a publisher website. The advertisement requests can also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, a publisher 106 can combine the requested content with one or more of the advertisements provided by the system 104. This combined page content 109 and advertisements can be sent to the user device 108 that requested the content (e.g., user device 108a) as page content 111 for presentation in a viewer (e.g., a browser or other content display system). The publisher 106 can transmit information about the advertisements back to the advertisement management system 104, including information describing how, when, and/or where the advertisements are to be rendered (e.g., in HTML or JavaScript™).

Publishers 106a and 106b can include general content servers that receive requests for content (e.g., articles, discussion threads, music, video, graphics, search results, web page listings, information feeds, etc.), and retrieves the requested content in response to the request. For example, content servers related news content providers, retailers, independent blogs, social network sites, or any other entity that provides content over the network 110 can be a publisher.

Advertisements can also be provided through the use of the search engine 112. The search engine 112 can receive queries for search results. In response, the search engine 112 can retrieve relevant search results from an index of documents (e.g., from an index of web pages). An exemplary search engine 112 is described in the article S. Brin and L. Page, “The Anatomy of a Large-Scale Hypertextual Search Engine,” Seventh International World Wide Web Conference, Brisbane, Australia and in U.S. Pat. No. 6,285,999. Search results can include, for example, lists of web page titles, snippets of text extracted from those web pages, and hypertext links to those web pages, and may be grouped into a predetermined number of (e.g., ten) search results.

The search engine 112 can also submit a request for advertisements to the system 104. The request may include a number of advertisements desired. This number may depend on the search results, the amount of screen or page space occupied by the search results, the size and shape of the advertisements, etc. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

The search engine 112 can combine the search results with one or more of the advertisements provided by the system 104. This combined information can then be forwarded to the user device 108 that requested the content as the page content 111. The search results can be maintained as distinct from the advertisements, so as not to confuse the user between paid advertisements and presumably neutral search results.

The advertisers 102, user devices 108, and/or the search engine 112 can also provide usage information to the advertisement management system 104. This usage information can include measured or observed user behavior related to advertisements that have been served, such as, for example, whether or not a conversion or a selection related to an advertisement has occurred. The system 104 performs financial transactions, such as crediting the publishers 106 and charging the advertisers 102 based on the usage information. Such usage information can also be processed to measure performance metrics, such as a click-through rate (“CTR”), conversion rate, etc.

A click-through can occur, for example, when a user of a user device selects or “clicks” on a link to a content item returned by the publisher or the advertising management system. The CTR is a performance metric that is obtained by dividing the number of users that clicked on the content item, e.g., a link to a landing page, an advertisement, or a search result, by the number of times the content item was delivered. For example, if a link to a content item is delivered 100 times, and three persons click on the content item, then the CTR for that content item is 3%. Other usage information and/or performance metrics can also be used.

A “conversion” occurs when a user consummates a transaction related to a previously served advertisement. What constitutes a conversion may vary from case to case and can be determined in a variety of ways. For example, a conversion may occur when a user clicks on an advertisement, is referred to the advertiser's web page, and consummates a purchase there before leaving that web page. A conversion can also be defined by an advertiser to be any measurable/observable user action such as, for example, downloading a white paper, navigating to at least a given depth of a website, viewing at least a certain number of web pages, spending at least a predetermined amount of time on a website or web page, registering on a website, etc. Other actions that constitute a conversion can also be used.

### § 2.0 Advertisement Auctioning

In addition to the advertisements being selected based on content such as a search query or web page content of a publisher, the advertisements can also be selected from an auction. The results of the auction can define an allocation of advertisements to presentation positions (e.g., advertisement slots on a web page, search result positions on a search results page, etc.). In some implementations, the advertisement management system 104 includes an allocation subsystem 130. The allocation subsystem 130 can be used by the advertisement management system 104 to determine an optimal allocation of advertisements to advertisement slots.

Advertisers 102 may be permitted to select, or bid, an amount the advertisers are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of an advertisement based on a keyword. For example, advertisers A, B, and C all select, or bid, a maximum cost-per-click of $2.00, $4.00, and $10.00, respectively. The maximum amount advertiser A will pay for a click is $2.00, the maximum amount advertiser B will pay is $4.00, and the maximum amount advertiser C will pay is $10.00.

### § 2.1 Co-Performance Allocation

The allocation subsystem 130 can implement an auction that selects advertisements based on each advertisement's independent performance. In some implementations, the allocation subsystem 130 selects advertisements in part, on the performance of the other advertisements that are selected. In these implementations, a user behavior model can be used to determine the performance of the selected advertisements.

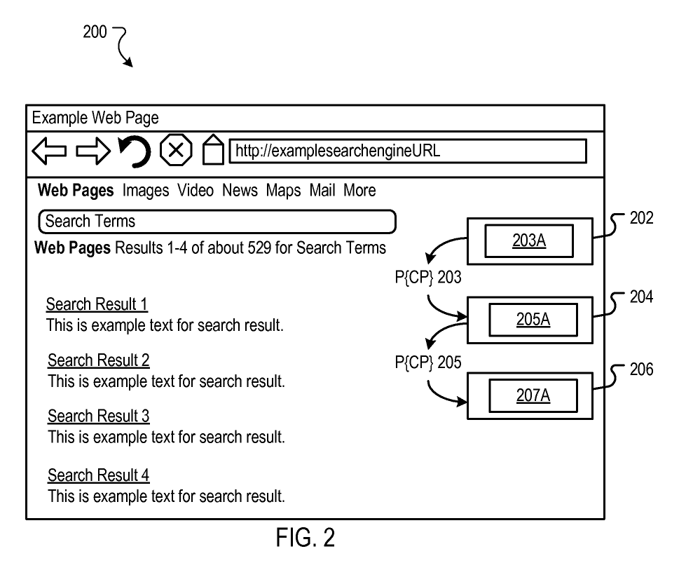

For example, the allocation subsystem 130 can conduct an advertisement auction that is based on a model that accounts for an advertisement's effect on performance of other advertisements that are presented on the page. Such effects are conceptualized in FIG. 2, which is a block diagram of an example web page 200 having advertisement slots 202, 204, 206. The model can be implemented, for example, to define the order in which advertisement slots are viewed on a page. In some implementations, the model can be based on performance measurements associated with the advertisements. For example, advertisement performance measurements can vary according to the advertisement slot that an advertisement occupies on the web page 200. Accordingly, determining the performance variance of advertisements that are a result of the advertisement slot occupied can be used to determine the order in which advertisement slots on a page are viewed.

For example, the model can define that a particular portion of a page (e.g., top right corner) is viewed first. Therefore, an advertisement located at a presentation position in that particular portion of the page can have a higher probability of being viewed. In turn, the performance (e.g., CTR) of the advertisement can increase when presented in that presentation position because more users are viewing the advertisement. Accordingly, presentation position performance can be modeled according to the performance variance of advertisements when presented in different presentation positions.

Advertisement performance metrics can also vary based on the other advertisements that are presented on the page. The measure of the performance variance associated with other advertisements can be referred to as a co-performance measure. In some implementations, the model can define a particular viewing order for advertisement slots on a web page 200 to determine the co-performance measurements. In the model, the advertisements that are presented in advertisement slots that are viewed and/or acted upon first can affect the performance of advertisements that are presented in other advertisement slots that are subsequently viewed.

In some implementations, the dependency of advertisement performance on other advertisements can be represented by the co-performance measurements. For example, the model can define advertisement slot 202 as being viewed first, followed by the advertisement slot 204 being viewed next, and advertisement slot 206 being viewed last. The performance of an advertisement presented in advertisement slot 204 depends partially on whether a user continues viewing advertisements after viewing the advertisement in the advertisement slot 202. Thus, the probability that an advertisement presented in the advertisement slot 204 will be clicked is partially dependent on the probability that a user continues to view advertisements after viewing the advertisement in the advertisement slot 202.

### § 2.1 Example Co-Performance Measurement

In some implementations, the co-performance measurement can be a continuation probability that indicates the probability that a user continues viewing other advertisements after viewing a particular advertisement. The continuation probability associated with a particular advertisement can be determined, for example, by observing the performance of other advertisements that are presented in advertisement slots that are subsequently viewed on the page according to the model. If the model defines that advertisement slots are viewed from the top to the bottom, then the co-performance measurement is determined based on this assumption.

For example, in FIG. 2, the performance of advertisements that are presented in the advertisement slot 204 will vary according to the continuation probability of the advertisement that is presented in advertisement slot 202, e.g., P{CP} 203. Likewise, the performance of the advertisement presented in the slot 206 will vary according to a function of the continuation probabilities of the advertisements presented in the advertisement slots 202 and 204, e.g., P{CP} 203 and P{CP} 205, respectively.

In some implementations, to determine the value of the continuation probability for a subject advertisement, the performance of advertisements that are presented in a next advertisement slot that is modeled as being viewed immediately after the slot in which the subject advertisement is presented is measured. The deviation of the performance of the advertisements that are presented in the next advertisement slot from their normal performance measures can be used to determine the continuation probability for the subject advertisement.

For example, to determine a continuation probability P{CP} 203 of an advertisement shown in the advertisement slot 202, e.g., advertisement 203A, the observed performance of advertisements when presented in an advertisement slot 204 are compared to their known performance measures (e.g., click-through-rate). The ratios of these performances can be used to establish the continuation probability of the advertisement, e.g.,

P{CP} 203=[WAverage(CTR1 . . . CTRn)|Ad 203A]/WAverage(CTR1 . . . CTRn)

where

WAverage(CTR1 . . . CTRn)|Ad 203A is the average of all click-through rates of advertisements 1-n shown in the advertisement slot 204 when the advertisement 203A is shown in advertisement slot 202; and

WAverage(CTR . . . CTRn) is the average of all click-through rates of advertisements 1-n independent of any other advertisements shown.

For example, assume the weighted average CTR for three advertisements with CTRs of 2%, 3%, and 4% is 3%, independent of any other advertisements. Also assume that the three advertisements are shown an equal number of times in the advertisement slot 204 when the advertisement 203A is shown in the slot 202. Further, assume that the observed value of WAverage(CTR1 . . . CTRn)|Ad 203A is 2%. The continuation probability P{CP} 203 is thus given by:

P{CP} 203=2%/3%=0.67

In summary, observing a variance of performance measures of advertisements that are presented with a particular advertisement can be used to determine a co-performance measure, e.g., a continuation probability, of the particular advertisement. The observations are based, in part, on the model that defines user interactions (e.g., viewing advertisements from top to bottom, or left to right, etc.) for measuring the co-performance measures.

Other models and measures can also be used. For example, a model of the effect that a click-through on a first advertisement has on other advertisements can be used.

### §3.0 Advertisement Allocation

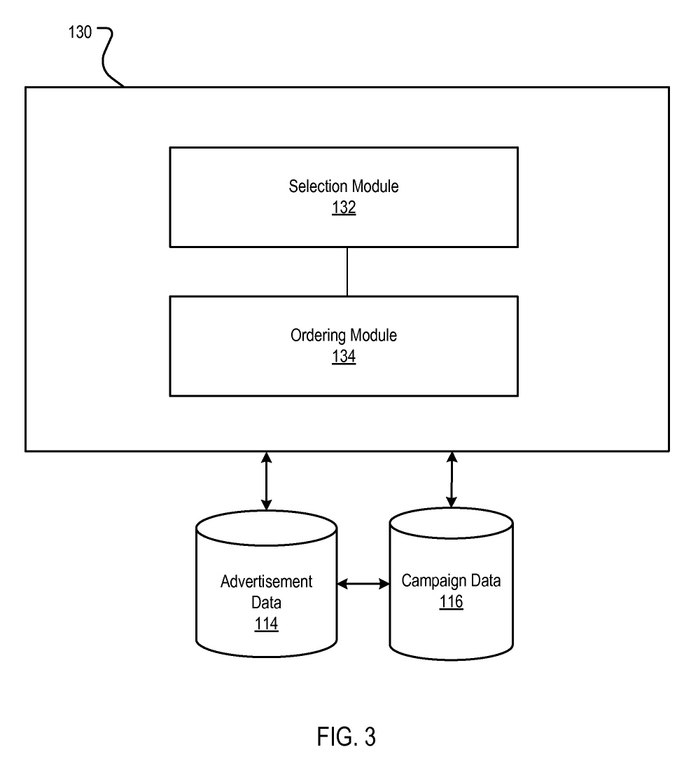

Advertisement allocation is the selection and placement of advertisements for an auction. Advertisement allocation can be performed, for example, by the allocation subsystem 130. FIG. 3 is a block diagram of an example allocation subsystem 130. In some implementations, the allocation subsystem 130 can include a selection module 132 and an ordering module 134. The selection module 132 can be configured to select advertisements for presentation, and the ordering module 134 can be configured to determine presentation positions for the selected advertisements.

In some implementations, advertisement allocation can be performed based on a performance metric. For example, advertisements can be allocated to maximize total revenue, value, or profit. In some implementations, advertisements can be allocated to maximize a cumulative performance of the advertisements on the page. For example, the cumulative performance can be a combined click-through rate for the advertisements on the page, the number of advertisements viewed, or a cumulative value to the advertisers (e.g., total page value).

The cumulative value to the advertisers can be maximized by summing the value that each advertiser derives from its advertisements being presented on a page. The value that an advertiser derives from being presented on a web page can be represented, for example, by the performance of the advertisement when presented on the web page. As discussed above, the performance of an advertisement can depend on co-performance measurements associated with the other advertisements that are presented on the page. Accordingly, the value that the advertiser derives from having an advertisement presented on the page can similarly depend on the co-performance measurements of the other advertisements that are presented on the page.

Determining the advertisements to be presented and the order of the presentation on a web page to maximize the cumulative value to the advertisers can depend on the number of advertising slots that are available on the web page and the number of advertisements that are competing for those slots. In general, if the advertisements in the auction are fewer or equal in number to the number of slots available, then the ordering module 134 need only arrange the advertisements competing in the auction for display. Conversely, if the advertisements in the auction are greater in number than the number of slots available, then the selection module 132 and ordering module 134 must determine which advertisements should be selected for display in the advertisement slots, and the order in which the advertisements should be displayed.

### §3.1 Advertisement Slots Equal or Outnumber Advertisements

When advertisement slots equal or outnumber the available advertisements, then the cumulative value to the advertisers is maximized by presenting all the advertisements on the page in an order that is dependent on their respective co-performance measurements. The ordering module 134 can, for example, assign the advertisements to presentation positions according to an adjusted impression value that is associated with each advertisement and is based on the co-performance measurement of each advertisement.

An impression value is a measure of the value that an advertiser derives from each impression of the advertisement. The ordering module 134 can determine the impression value associated with an advertisement, for example, by multiplying the maximum cost-per-click associated with the advertisement by a CTR associated with the advertisement. For example, suppose the CTRs of advertisers A, B, and C are “0.5,” “0.25,” and “0.085,” respectively. Additionally, as discussed above, suppose that advertisers A, B, and C have submitted maximum cost-per-click bids of $2.00, $8.00, and $10.00, respectively. The impression value of advertiser A, B, and C can be determined as follows:

Impression Value=CTR×maximum cost-per-click=0.5×$2.00=1.00 A

Impression Value=CTR×maximum cost-per-click=0.25×$8.00=2.00 B

Impression Value=CTR×maximum cost-per-click=0.085×$10.00=0.85 C

The ordering module 134 can adjust the impression value associated with each advertiser's advertisement based on the continuation probability associated with the advertisement. As discussed above, the continuation probability represents the likelihood that an additional advertisement will be viewed after the advertisement associated with the continuation probability is viewed. Accordingly, the ordering module 134 can use the continuation probability to account for the negative impact that the advertisement has on other advertisements that are located in subsequently viewed presentation positions on the page, according to the model. For example, the ordering module can adjust the impression value by applying the ratio:

$$\frac{1}{( 1 - q )}$$

where q is the continuation probability value.

The impression value for an advertisement will increase in proportion to the magnitude of its associated continuation probability. For example, if the advertisement is associated with a continuation probability of 0.5, the impression value of the advertisement will double. However, if the advertisement is associated with a continuation probability equal to 0 then the impression value will not be increased.

Continuing with the example above, suppose that advertisements A, B, and C are from advertisers A, B, and C respectively, and that advertisements A, B, and C are associated with continuation probabilities of 0.75, 0.2, and 0.8, respectively. The resulting adjusted impression values for advertisements A, B, and C are 4, 2.5, and 4.25, respectively.

In some implementations, the ordering module 134 can assign the advertisements to presentation positions (e.g., advertisement slots) in descending order of adjusted impression value to maximize the cumulative value of the advertisers. For example, continuing the above example, advertisements C, A, and B can be respectively assigned to the first, second, and third viewed advertisement slots according to the model.

Other measurements or factors can be used to assign advertisements to presentation positions, e.g., click-through-rate, total clicks, quality scores, etc.

### §3.2 Advertisements Outnumber Advertisement Slots

When advertisements outnumber the available advertisement slots, then the selection module 132 selects from all eligible advertisements the advertisements that, for example, will result in the maximum cumulative value. In turn, the ordering module 134 can allocate the advertisements to presentation positions, e.g., advertisement slots. In some implementations, the selection module 132 can determine the cumulative value for the advertisements according to equation 1:

Cumulative Value=eₓ₁+qₓ₁(eₓ₂+qₓ₂(eₓ₃+qₓ₃( . . . qₓₙ₋₁(eₓₙ)))) Equation 1

where

eₓₙ is the impression value for advertisement n; and

qₓₙ is the continuation probability associated with advertisement n.

In some implementations, the selection module 132 can determine which advertisements maximize the cumulative value, for example, by recursively determining the cumulative value for each possible combination of advertisements. The selection module 132 can then identify the maximum cumulative value from among the set of cumulative values for the combinations, and in turn, identify the advertisements that are associated with the maximum cumulative value as an optimal set of advertisements.

In some implementations, the selection module 132 can determine which advertisements maximize the cumulative value by determining an optimal set of advertisements using dynamic programming. In other implementations, the selection module 132 can determine which advertisements maximize the cumulative value by determining an optimal set of advertisements using a near-linear time algorithm.

### § 3.2.1 Dynamic Programming

In some implementations, the set of optimal advertisements can be determined using dynamic programming. In these implementations, the selection module 132 can sort the advertisements in decreasing order of adjusted impression value. In some implementations, the sorting can be done in O(n log n) time, where n is the number of advertisements that are available for presentation. The selection module 132 can then recursively determine the cumulative value obtained by filling advertisement slots (j, . . . , k) with advertisements from the set of advertisements {i, . . . , n}. In some implementations, this recursion is represented by equation 2:

F(i,j)=max(F(i+1,j+1)qᵢ+eᵢ,F(i=1,j)) Equation 2

where

F(i,j) is the cumulative value obtained by filling advertisement slots (j, . . . k) with advertisements from the set of advertisements {i, . . . , n},

qᵢ is the continuation probability associated with advertisement i, and

eᵢ is the impression value associated with advertisement i.

Solving equation 2 for F(1,1) yields the optimal assignment. The optimal assignment can be determined recursively according to equation 2.

### § 3.2.2 Linear-Time Processing

In some implementations, the optimal set of advertisements can be determined using a linear time algorithm. In these implementations, the selection module 132 can select the optimal set of advertisements from the available advertisements [1, . . . , n]. The selection module 132 can, for example, consider dyadic intervals [α2^{β}+1, . . . , (α+1)2^{β}] for each possible α, β, for a total of O(n) intervals, where α is 1, . . . , n/2^{β} and β is 1, . . . , log(n) or 0, . . . , log(n−1). For any subsequence [j, . . . , j′], there is a maximum of O(log n) intervals. The selection module 132 can implement a data structure that can be used to identify a maximum f(qₓ, eₓ) for the advertisements in each interval in O(log n) time, where f is a linear function.

In some implementations, the data structure for a particular interval can be the convex hull of the points (qₓ, eₓ) in two dimensional space defined by advertisements x in the interval. The convex hulls can be computed by successively merging convex hulls for increasing β. In turn, the selection module 132 can find the point that maximizes f(qₓ, eₓ) using the convex hull. Thus, for any j, j′ there is an advertisement y that maximizes f(q_{y},e_{y}) for the linear function f, where j≦y≦j′.

The selection module 132 can then select a set of advertisements Sᵢ for all advertisement positions i=1, . . . , k, where Sᵢ₊₁ is a superset of Sᵢ and Sₖ is the optimal set of advertisements. Sᵢ₊₁ can be determined, for example, by determining the maximum impression value of the union of Sᵢ and another advertisement x that is in the subset of advertisements that are not already included in Sᵢ. In some implementations, the maximum Sᵢ₊₁ can be determined by identifying an adjusted impression value rank of the advertisement x among the advertisements that are included in Sᵢ. This rank can be a number l from 1 to i+1. The selection module 132 can sort the advertisements that are included in Sᵢ by decreasing adjusted impression value, e.g., {s₁, . . . , sᵢ}. The selection module 132 can select advertisement x so that it has an adjusted impression value that is between sₗ₋₁ and sₗ. Accordingly, the impression value of the union of advertisement Sᵢ and advertisement x can be represented according to equation 3:

e(Sᵢ∪){x})=e(sᵢ, . . . , sᵢ₋₁)+q(s₁, . . . , sₗ₋₁)(eₓ+qₓe(sₗ, . . . , sᵢ))

Since e(SᵢU{x}) is linear in (qₓ,eₓ), the selection module 132 can identify the advertisement x that maximizes the impression value of the union of the set of advertisements Sᵢ and advertisement x. For example, the selection module can make i+1 calls to the oracle for each i, thereby performing O(k2) calls overall.

In some implementations, the selection module 132 can determine the co-performance measurement (e.g., qᵢ) and the impression value (e.g., e(i)) associated with each advertisement and provide this information to the oracle prior to advertisement set selection.

Once the optimal set of advertisements is selected by the selection module, the ordering module 134 can allocate the selected advertisements to presentation positions (e.g., advertisement slots) based on each advertisement's adjusted impression value, as discussed above.

While particular processes for selecting an optimal set of advertisements are provided for purposes of illustration, other processes can be used to determine an optimal set of advertisers.

### §4.0 Actual Cost-Per-Click

Once the advertisements have been selected for presentation and assigned to presentation positions, the allocation subsystem 130 can assign an actual price (e.g., cost-per-click) that will be paid by each advertiser. In some implementations, the allocation subsystem 130 can assign an actual price using a truthful auction. Truthful auctions are auctions that provide an incentive for each bidder to submit a bid that represents the true value that the bidder associates with the item being auctioned. An example of a truthful auction is a Vickery-Clarke-Groves (VCG) auction.

In some implementations, the VCG auction can maximize the total valuation of advertisements that are presented on a page. The VCG auction can maximize advertisement value, for example, by setting a price for each advertisement that is equal to the opportunity cost that the advertisement's presentation imposes on other presented advertisements. Accordingly, an advertiser has an incentive to bid the true value that it derives from being presented, rather than submitting a bid that is higher or lower than its true valuation because the actual price paid by the advertiser is only dependent on the bids associated with the other presented advertisements.

In some implementations, when advertisements are positioned by the allocation subsystem 130, as described above, the actual price paid for allocation of a particular advertisement can be determined by calculating the combined loss in value experienced by the other advertisements because the particular advertisement was allocated an advertisement slot. For example, the price can be the combined value that the other advertisements would have received had the particular advertisement not been presented minus the combined value that the other advertisements receive when the particular advertisement is presented.

### §5.0 Example Allocation Process

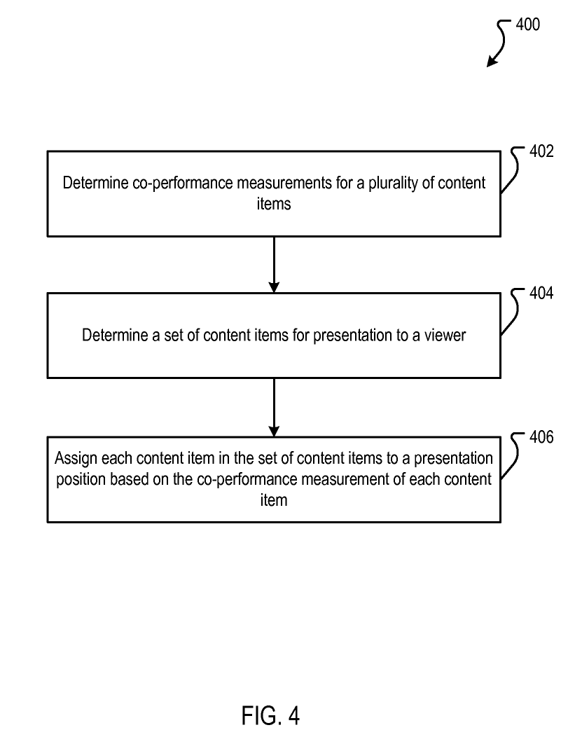

FIG. 4 is a flow chart of an example process 400 for allocating content items. The process can be implemented, for example, in the allocation subsystem 130 of FIG. 3. In some implementations, the content items can be advertisements that are presented on a web page.

Stage 402 determines co-performance measurements for a plurality of content items. In some implementations, each co-performance measurement can be associated with a corresponding content item. The co-performance measurements can be a measure of the effect that the corresponding content item has on other content items that are presented with the corresponding content item. In these implementations, the co-performance measurements can be continuation probabilities. The co-performance measurements can be determined, for example, by the advertisement management system 104 as described in section 2.1 above, or by other schemes in which the performance effect of a particular advertisement on the performance of other advertisements can be observed and measured. The co-performance measurements can be stored, for example, in the advertisement data store 114 or the campaign data store 116.

Stage 404 of the example process 400 determines a set of content items for presentation to a viewer. The set of content items can be the content items that maximize a cumulative performance of the set of content items. In some implementations, the cumulative performance can be a cumulative presentation position value on a web page. The cumulative presentation position value for the web page can be determined, for example, by iteratively determining the value of the web page presentation positions based on the performance of each advertisement and the effects of the co-performance measurements on each advertisement. The set of content items for presentation to a viewer can be determined, for example, by the selection module 132 as described in section 3 above, or by other selection schemes.

Stage 406 assigns each content item in the set of content items to a presentation position based on the co-performance measurement of each content item. In some implementations, the set of content items can be assigned to presentation positions in descending order of an adjusted impression value. The adjusted impression value can be determined, for example, by multiplying the impression value for each content item by 1/(1−q) to account for the negative impact that the advertisement has on the content items below it. The content items can be assigned to presentation positions, for example, by the ordering module 134.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. While reference is made to delivering advertisements, other forms of content including other forms of sponsored content can be delivered.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
determining co-performance measurements for a plurality of content items, each co-performance measurement being associated with a corresponding content item and each co-performance measurement being a measure of an effect of the corresponding content item on a performance of one or more other content items that are presented with the corresponding content item; and
determining a set of content items for presentation to a viewer, wherein the set of content items comprises content items that maximize a cumulative performance of the set of content items; and
assigning each content item in the set of content items to a presentation position based on a co-performance measurement of each content item.

2. The method of claim 1, wherein determining the co-performance measurements comprises determining continuation probabilities.

3. The method of claim 2, wherein each continuation probability represents a probability that the viewer views another content item in response to viewing the content item.

4. The method of claim 1, wherein the content item is an online advertisement.

5. The method of claim 4, wherein determining the co-performance measurements comprises determining click-through rates.

6. The method of claim 5, wherein the set of content items comprises the online advertisements that maximize a cumulative presentation position value on a web page.

7. The method of claim 5, wherein assigning each content item in the set of content items to a presentation position based on the co-performance measurement of each content item comprises assigning each online advertisement to a presentation position based on an adjusted estimated cost.

8. The method of claim 7, wherein the adjusted estimated cost is an estimated cost per thousand impressions that is adjusted by the continuation probability.

9. The method of claim 1, further comprising:
receiving a content item bid corresponding to each content item; and
determining an actual price paid for each presentation position according to a truthful auction.

10. The method of claim 9, wherein the truthful auction mechanism is a Vickery-Clarke-Groves auction.

11. The method of claim 9, wherein the content item bid comprises a maximum cost-per-click.

12. A computer-implemented method, comprising:
determining a model that defines a viewing order for presentation positions in a set of presentation positions;
determining a continuation probability for a plurality of advertisements, each continuation probability being associated with a corresponding advertisement;
determining a set of advertisements for allocation to the presentation positions, wherein the set of advertisements comprises advertisements that maximize a cumulative value of the presentation positions; and
assigning each advertisement in the set of advertisements to a presentation position in the set of presentation positions based on an adjusted impression value of each advertisement.

13. The method of claim 12, wherein determining a set of advertisements for allocation to the presentation positions comprises:
determining an impression value associated with each advertisement in the set of advertisements;
identifying each subset of advertisements from the set of advertisements that can be placed in the presentation positions;
determining the cumulative value of the presentation positions for each allocation of each subset of advertisements, wherein the value of each presentation position is based on an impression value associated with the advertisement allocated to that presentation position and a continuation probability of advertisements allocated to advertisement slots that are previously viewed, according to the model; and
selecting the subset of advertisements that are associated with a maximum cumulative value.

14. A system, comprising:
a selection module to determine co-performance measurements for a plurality of content items, each co-performance measurement being associated with a corresponding content item and each co-performance measurement being a measure of an effect of the corresponding content item on a performance of one or more other content items that are presented with the corresponding content item, and further to determine a set of content items for presentation to a viewer, wherein the set of content items comprises content items that maximize a cumulative performance of the set of content items; and
an ordering module to assign each content item in the set of content items to a presentation position based on a co-performance measurement of each content item.

15. The method of claim 14, wherein the co-performance measurements comprise continuation probabilities.

16. The method of claim 15, wherein each continuation probability represents a probability that the viewer views another content item in response to viewing the content item.

17. The method of claim 14, wherein the content item is an online advertisement.

18. The method of claim 17, wherein the set of content items comprises online advertisements that maximize a cumulative presentation position value on a web page.

19. The method of claim 17, wherein the ordering module assigns each content item in the set of content items to a presentation position based on an adjusted estimated cost.

20. The method of claim 19, wherein the adjusted estimated cost is an estimated cost per thousand impressions that is adjusted by the continuation probability.

21. A device, comprising:
means for determining co-performance measurements for a plurality of content items, each co-performance measurement being associated with a corresponding content item and each co-performance measurement being a measure of an effect of the corresponding content item on a performance of one or more other content items that are presented with the corresponding content item;
means for determining a set of content items for presentation to a viewer, wherein the set of content items comprises content items that maximize a cumulative performance of the set of content items; and
means for assigning each content item in the set of content items to a presentation position based on a co-performance measurement of each content item.

22. The device of claim 21, further comprising:
means for receiving a content item bid corresponding to each content item; and
means for determining an actual price paid for each presentation position according to a truthful auction.
